(19) United States
(12) Patent Application Publication
(10) Pub. No.: US 2009/0277798 A1
(43) Pub. Date: Nov. 12, 2009

(54) CATALYST ATTACHMENT-ENHANCING AGENT

(75) Inventors: Hajime Nakamura, Kanagawa (JP); Yoshinori Kanao, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Ebara-Udylite Co. Ltd., Taito-Ku (JP)

(21) Appl. No.: 12/065,447

(22) PCT Filed: Aug. 28, 2006
(86) PCT No.: PCT/JP2006/316890

§ 371 Date: Feb. 29, 2008

(30) Foreign Application Priority Data
Sep. 2, 2005 (JP) 2005 254872

(51) Int. Cl. C25D 5/34; C08G 73/02

(52) U.S. Cl. 205/183; 528/424

(57) ABSTRACT

Disclosed is a technique for direct plating which causes no deposition of a metal on the rack coating. A catalyst attachment-enhancing agent comprising a high molecular compound having primary, secondary and tertiary amino groups as active ingredient; and a method for direct electroplating onto a Pd/Sn colloidal catalyst which has been subjected to a conductivity-imparting treatment, comprising the step of, prior to the attachment of the Pd/Sn colloidal catalyst to a non-conductive material, treating the non-conductive material with a catalyst attachment-enhancing agent which comprises a high molecular compound having primary, secondary and tertiary amino groups as an active ingredient.

### TECHNICAL FIELD

The present invention relates to a catalyst attachment-enhancing agent, and more specifically to a catalyst attachment-enhancing agent advantageously usable particularly as a conditioner in direct electroplating that performs electroplating directly on nonconductor materials such as plastics.

### BACKGROUND ART

In applying plating on a nonconductor material such as plastic or a printed circuit board, it has been a common practice to roughen the surface of the nonconductor material; to apply a palladium/tin colloidal catalyst (hereinafter referred to as a “Pd/Sn colloidal catalyst”) in general; to conduct activation treatment to form palladiummetal; to conduct electroless metal plating while using the palladium metal as nuclei; and then to apply electroplating to the deposited metal.

In recent years, however, for the purposes of improved productivity, reduced environmental loads and the like, direct plating has been developed to directly conduct electroplating on the surface of a nonconductor material such as plastic, a printed circuit board, or the like without electroless metal plating step. According to this direct plating, conductivity-imparting treatment is conducted after catalyst application treatment to form an extremely thin film of metal palladium on the surface of a nonconductor material so that electroplating can be applied without the need for electroless metal plating.

With direct plating, however, it is required to form the palladium film on the nonconductor material although it is extremely thin. Electroplating, therefore, involves a problem in that a catalyst of high concentration has to be used compared with electroless metal plating. Especially when applying plating to an acrylonitrile-butadiene-styrene resin (ABS resin) or the like, it is considered that a catalyst needs a concentration 3 to 5 times as high as that used in electroless metal plating.

The use of a catalyst at such high concentration, however, has led to the development of a new problem that deposition of a metal takes place on a coating of a rack used in direct plating. Described specifically, a process making use of conventional electroless plating allows to practically ignore palladium metal on an insulating coating of a rack made of plastic since the degree of etching by roughening treatment differs between an item under plating and the insulating coating and further, the catalyst concentration is low. In direct electroplating, on the other hand, the catalyst concentration needs to be set high, so that the amount of metal palladium deposited on the insulating coating of the rack becomes unignorable and a metal may often deposit on the metal palladium.

Especially, in case that the material of an item to be plated by direct plating is an ABS-resin-based alloy polymer represented by a PC/ABS resin obtained by blending a polycarbonate resin with an ABS resin (which may hereinafter be referred to as “PC/ABS resin”) or the like, it is necessary not only to raise the catalyst concentration but also to perform conditioning treatment before application of the catalyst so that the catalyst adsorption can be promoted. The application of this conditioning treatment, however, facilitates the deposition (plating) of an unnecessary metal on the coating of the rack, and upon conducting plating, it is hence essential to replace the rack thereby making it virtually impossible to conduct electroplating by the single-rack method.

To prevent such unnecessary metal deposition (plating) on a coating of a rack and to permit conducting electroplating by the single-rack method, there are conventionally known a rack coated with a fluororesin except for the current-feeding parts (Patent document 1) or a rack with insulating coatings of a fluororesin or the like formed at parts thereof with which items to be plated will remain out of contact (Patent document 2). However, these methods are not practical in the way that almost the entire surface of the rack need to be coated with a fluororesin or the like, which is expensive. Thus, measures for preventing metal deposition on a rack through improvements in the process to conductivity-imparting treatment.

[Patent document 1] JP-A-05-148692

[Patent document 2] JP-A-06-10197

### DISCLOSURE OF THE INVENTION

### Problems that the Invention is to Solve

It has, therefore, been desired to develop a technique with which no metal deposition on an insulating coating of rack is caused even in direct plating process, and the object of the present invention is to provide such technique.

### Means for Solving the Problems

To achieve the above-described object, the present inventors have conducted extensive research. As a result, it has been found that the use of a substance having various forms of amino groups as a conditioner can increase only the amount of a catalyst to be adsorbed on plastic such as a PC/ABS, which is to be plated, without increasing the amount of the catalyst to be adsorbed on a coating material for a rack, such as hard polyvinyl chloride sol, even at high catalyst concentration, leading to the completion of the present invention.

In one aspect of the present invention, there is thus provided a catalyst attachment-enhancing agent comprising, as an effective component, a high molecular compound containing primary, secondary and tertiary amino groups.

In another aspect of the present invention, there is also provided a process of performing direct electroplating on a palladium/tin colloidal catalyst applied for conductivity-imparting treatment of a nonconductor material, which comprises, before application of the palladium/tin colloidal catalyst, treating the nonconductor material with a catalyst attachment-enhancing agent comprising, as an effective component, a high molecular compound containing primary, secondary and tertiary amino groups.

### ADVANTAGE OF THE INVENTION

By treating the nonconductor material with the catalyst attachment-enhancing agent of the present invention before applying a Pd/Sn colloidal catalyst, it is possible to increase only the amount of the catalyst to be adsorbed on the nonconductor material, which is to be plated, without increasing the amount of the colloidal catalyst to be adsorbed on an insulating coating on a rack.

Accordingly, it becomes unnecessary to replace the rack even when conducting so-called direct plating that has omitted electroless plating, thereby making it possible to significantly improve the efficiency of the work.

### BEST MODE FOR CARRYING OUT THE INVENTION

The catalyst attachment-enhancing agent according to the present invention may be used after etching a nonconductor material but before applying a Pd/Sn colloidal catalyst, that is, in so-called conditioning treatment. It is preferably usable especially in direct plating (a process in which after reduction of Pd in an adsorbed Pd/Sn colloidal catalyst, electroplating is immediately conducted), which requires adsorption of a Pd/Sn colloidal catalyst in a large amount.

The term “high molecular compound containing primary, secondary and tertiary amino groups”, which is the effective component of the catalyst attachment-enhancing agent according to the present invention and which will hereinafter be called a “compound with the various amino groups contained therein”, means a high molecular compound containing primary amino groups, secondary amino groups and tertiary amino groups all together in its structure.

The compound with the various amino groups contained therein is a compound obtained, for example, by ring-opening polymerization of high-purity ethyleneimine in the presence of an acid catalyst (polyethyleneimine). This is not a completely linear polymer, but is a polymer with a branched structure containing primary, secondary and tertiary amines, is extremely high in cation density, is water-soluble and also has high reactivity.

Its molecular weight may preferably be 250 to 10,000. The primary amino groups, secondary amino groups and tertiary amino groups in a molecule (as determined by ¹³C-NMR) may preferably be, for example, at a ratio of 1:approx. 0.7 to 2:approx. 0.4 to 1.2.

It is to be noted that the compound with the various amino groups contained therein is commercially available from Nippon Shokubai Co., Ltd., for example, under the trade name of “EPOMIN SP-003”, “EPOMIN SP-006”, “EPOMIN SP-012”, “EPOMINSP-018”, “EPOMINSP-200”, “EPOMINSP-103”, “EPOMIN SP-110” or the like and such a commercial product can also be used.

The catalyst attachment-enhancing agent of the present invention contains the above-described compound with the various amino groups contained therein as its effective component and is preferably obtained by dissolving the above-described compound with the various amino groups contained therein in aqueous solvent such as water. The concentration of the compound with the various amino groups contained therein is may be, but not particularly limited thereto, 50 to 500 mg/L or so, preferably 100 to 300 mg/L at the time of use. It can also be used at a high concentration of 500 mg/L or higher, for example, at 2 to 5 g/L without any particular reduction in performance. However, such a high range is not preferred, because it is uneconomical and moreover, raises a problem that the load of wastewater treatment becomes greater.

Further, the catalyst attachment-enhancing agent of the present invention is preferably used under alkaline conditions, specifically at a pH of 9 to 13, with 10 to 12 being more preferred. When the compound with the various amino groups contained therein is used at a high concentration, the pH of the enhancer naturally falls within the above range. When the compound is used at a low concentration, however, a buffer is preferably used to maintain the pH of the enhancer within the above-mentioned range. No particular limitation is imposed on the buffer to be used for the maintenance of the pH of the enhancer when the compound with the various amino groups contained therein is used at a low concentration, insofar as it can control within a target range pH variations caused by an acid carried in from the preceding step. It is preferable to use a buffer of a formulation comprising borax and sodium hydroxide in combination or a formulation making use of a phosphate, phthalic acid or the like. For the catalyst attachment-enhancing agent of the present invention, the use of a buffer to permit using the compound with the various amino groups at a low concentration is preferred because it is economical and can significantly reduce the load of wastewater treatment. With a view of suppressing the effects of chromic acid possibly carried in from the preceding etching step, it is also preferred to mix, in advance, a reducing agent such as hydrazine in the catalyst attachment-enhancing agent. As an alternative, a reducing step may be included after the etching step to achieve the same advantageous effect.

As has been described above, the catalyst attachment-enhancing agent of the present invention can be used as will be described hereinafter. Specifically, a nonconductor material (material to be plated) which has been etched according to a known technique is thoroughly washed and is then immersed in the catalyst attachment-enhancing agent of the present invention to conduct conditioning treatment.

The conditioning treatment is effected under known conditions, for example, the treatment temperature being 10 to 60° C., preferably 20 to 30° C., and the treatment time being 0.5 to 5 minutes, preferably 1 to 2 minutes.

The nonconductor material subjected to the conditioning treatment with the catalyst attachment-enhancing agent of the present invention as described above is then subjected to Pd/Sn colloidal catalyst application by a common method, followed by Pd reduction treatment and then plating. Although the plating may be direct plating which directly performs electroplating or may be a conventional method in which electroplating is performed after electrolessplating, the adoption of direct plating can bring about the advantageous effect of the present invention to higher level.

According to the present invention, it is possible to achieve good plating on plastic materials by direct plating (direct electroplating), which does not use electrolessplating, without causing deposition on the coating of a rack despite of the attainment of high catalyst concentration. This may be attributed to the following reasons.

With a known conditioner composed primarily of a cationic surfactant or cationic polymer containing quaternary ammonium group or groups, it is possible to significantly increase the amount of a catalyst to be adsorbed on a nonconductor material such as a plastic material. At the same time, however, conditioning is also applied to the rack coating formed of a hard polyvinyl chloride sol and when the catalyst concentration is high, a metal film may deposit on the coating of the rack.

With the catalyst attachment-enhancing agent of the present invention, on the other hand, the primary and secondary amino groups contained therein prevent the adsorption of the Pd—Sn colloidal catalyst on the hard polyvinyl chloride sol while with the tertiary amino group contained in the enhancer, conditioning is performed on a nonconductor material such as ABS resin or PC/ABS resin to selectively increase the adsorption of the Pd—Sn colloidal catalyst.

Especially by controlling the pH of the catalyst attachment-enhancing agent of the present invention, it is possible to adjust the amount of the catalyst, which is to be adsorbed onto a nonconductor material, to a desired range. Hence, even when the Pd/Sn colloidal catalyst is used at a concentration as high as 4 to 6 times the concentration required in usual electroless plating, no plating deposits on the coating of the rack, whereby good plating is feasible for the nonconductor material.

### EXAMPLES

The present invention will next be described in more detail based on Examples. It is, however, to be noted that the present invention is not limited by or to them.

### Example 1

Conditioning effects of polyethyleneimine (PEI; “SP-006”, trade name; product of Nippon Shokubai Co., Ltd.), a compound with various amino groups contained therein according to the present invention, were tested in direct plating on PC/ABS resin in terms of palladium adsorption amount, deposition on a rack, plating performance and wastewater treatment readiness.

Used as comparative samples in the test were ethylendiamine (EDA), a primary amine compound; triethylenetetramine (TET), a compound with primary and secondary amino groups; diethylethanolamine (DEEA), a tertiary amine compound; and a high-molecular quaternary ammonium surfactant (“CATION AB”, trademark; product of NOF Corporation), a common conditioner.

Steps and conditions of direct plating are shown in Table 1. The results of the individual tests are shown in Table 2. It is to be noted that substantially the same results were obtained even when the reduction treatment step was omitted.

TABLE 1

| Step | Composition of treatment solution | | | Temperature | Treatment time | |
|---|---|---|---|---|---|---|
| Smoothing | Sulfuric acid | 20 | mL/L | 50° C. | 10 | minutes |
| | “ENILEX WE” * | 10 | mL/L | | | |
| Etching | Chromic anhydride | 400 | g/L | 68° C. | 10 | minutes |
| | Sulfuric acid | 400 | g/L | | | |
| | “MISTSHUT CRL-CONC” * | 0.02 | g/L | | | |
| Reduction | Sulfuric acid | 30 | mL/L | 25° C. | 1 | minute |
| | “ENILEX RDII” * | 3 | mL/L | | | |
| Conditioning | (Individual conditioner samples) | 200 | mL/L *** | 25° C. | 2 | minutes |
| Pre-dipping | Hydrochloric acid | 300 | mL/L | Room temperature | 1 | minute |
| Activation | “D-POP ACTIVATOR” * | 50 | mL/L | 35° C. | 4 | minutes |
| | Hydrochloric acid | 100 | mL/L | | | |
| | Sodium chloride | 100 | g/L | | | |
| Metalization | “D-POP METALIZER A” * | 100 | mL/L | 45° C. | 3 | minutes |
| | “D-POP METALIZER B” * | 250 | mL/L | | | |
| Copper strike ** | Copper sulfate (pentahydrate) | 150 | g/L | 25° C. | 5 | minutes |
| | Sulfuric acid | 150 | g/L | | | |
| | Chlorine | 60 | mg/L | | | |
| | “CU-STRIKE(II)MU” * | 3 | mL/L | | | |

* Chemicals other than those shown in their general chemical names are trade names of Ebara-Udylite Co., Ltd.
** In copper strike, a current was initially applied for about 1 minute (0.5 V for 30 seconds and 1 V for 30 seconds) to give a soft start, and was finally raised to 1.5 V.
*** Concentration of individual sample with respect to solvent (water).

TABLE 2

| | Conditioner | | | | | |
|---|---|---|---|---|---|---|
| | None | EDA | TET | DEEA | PEI | Cationic surfactant |
| Pd adsorption amount (mg/dm⁻) * | 0.306 | 0.398 | 0.436 | 0.342 | 0.699 | 0.788 |
| Deposition on rack ** | B | B | B | B | B | D |
| Plating performance (on formed | D | C | B | C | B | B |
| product) *** | | | | | | |
| Wastewater treatment readiness **** | A | D | D | D | C | B |

* Pd adsorption amount was determined by measuring with an inductively-coupled plasma atomic emission spectrometer (ICP) the amount of palladium adsorbed on PC/ABS resin test piece containing 60% of polycarbonate after catalyst application treatment.
** Deposition on rack was evaluated by visually observing a rack made of PC/ABS resin test piece containing 60% of polycarbonate after copper strike plating. The assessment results were ranked in accordance with the following ranking standard:
B: No copper deposition on rack
D: Presence of copper deposition on rack
*** Plating performance was assessed by determining the percentage of coating of a door handle made of PC/ABS resin containing 60% of polycarbonate after completion of 3-minute copper strike. The assessment results were ranked in accordance with the following ranking standard:
A: Coating of 100%
B: Coating of 70% or more, less than 100%
C: Coating of 40% or more, less than 70%
D: Coating of less than 40%
**** Wastewater treatment readiness was assessed based on whether or not copper was successfully removed by a conventional coagulation sedimentation method from each conditioner with copper sulfate added at 10 ppm. The assessment results were ranked in accordance with the following ranking standard:
A: Copper removal rate of 80% or more
B: Copper removal rate of 50% or more, less than 80%
C: Copper removal rate of 20% or more, less than 50%
D: Copper removal rate of less than 20%

### Example 2

Effects of the pH of the catalyst attachment-enhancing agent were investigated as will be described next. The pH of the catalyst attachment-enhancing agent containing PEI of Example 1 at 200 mg/L was adjusted to 9.86 and 11.1 with a borax-sodium hydroxide buffer solution.

Using those catalyst attachment-enhancing agent samples, direct plating was conducted in a similar manner as in Example 1 to test them in terms of Pd adsorption amount, deposition on rack, plating performance and wastewater treatment readiness. The results are shown in Table 3.

TABLE 3

pH

| | 9.86 | 11.1 |
|---|---|---|
| Pd adsorption amount (mg/dm²) | 0.699 | 0.528 |
| Deposition on rack | B | B |
| Plating performance (on formed | B | B |
| product) | | |

From the results, it has been found that the lower the pH of the enhancer the greater the catalyst application enhancement. It has been recognized that, when PEI is used at a low concentration, an excessively low pH tends to have a metal deposited on a rack coating. It has, therefore, been indicated that, when the catalyst attachment-enhancing agent of the present invention is used at a low concentration, a pH buffer solution should be used as a method for maintaining the pH within a suitable range.

### Example 3

With respect to similar door handles as those used in Example 1, the plating performance was tested by direct plating while using catalyst attachment-enhancing agents containing varied concentrations of PEI or catalyst attachment-enhancing agents containing other component or components. The treatment steps were the same as those in Example 1. The results are shown in Table 4.

TABLE 4

| Composition of catalyst | |
|---|---|
| attachment-enhancing agent | Plating performance |
| PEI(500 mg/L) | Good |
| PEI(250 mg/L) | Good |
| PEI(100 mg/L) | Good |
| NaOH(0.1M) | |
| PEI(250 mg/L) | Good |
| NaOH(0.1M) | |
| Hydrosulfite soda(0.4 g/L) | |

As can be seen from the results, with concentrations of up to 100 mg/L, the catalyst attachment-enhancing agent was successfully used without any problem. It has also been found that, when hydrosulfite soda is added to reduce chromic acid carried in from the preceding step, no problem arises in plating performance.

### INDUSTRIAL APPLICABILITY

According to the present invention, it has become possible to provide the adsorbability of a Pd/Sn colloidal catalyst with selectivity between an etched nonconductor material such as ABS resin or PC/ABS resin and a hard polyvinyl chloride resin coating as a coating material for a rack.

The use of the process according to the present invention can stably perform direct plating on a nonconductor material without needing to replace racks and conduct troublesome setting of various conditions, and therefore, can improve the efficiency of the work.

1. A catalyst attachment-enhancing agent, comprising as an effective component a high molecular compound containing primary, secondary and tertiary amino groups.

2. A catalyst attachment-enhancing agent according to claim 1, wherein said high molecular compound has a molecular weight of 250 to 10,000.

3. A catalyst attachment-enhancing agent according to claim 1 or 2, wherein a content of said high molecular compound is 50 to 500 mg/L.

4. A catalyst attachment-enhancing agent according to any one of claims 1 to 3, which is used before application of a palladium/tin colloidal catalyst to increase an amount of said colloidal catalyst to be applied on a nonconductor material.

5. A catalyst attachment-enhancing agent according to any one of claims 1 to 4, which is useful in a process of performing direct electroplating on a palladium/tin colloidal catalyst applied for conductivity-imparting treatment.

6. The catalyst attachment-enhancing agent according to claim 4 or 5, wherein said nonconductor material is an acrylonitrile-butandiene-styrene resin or a polycarbonate-resin-blended acrylonitrile-butandiene-styrene alloy polymer.

7. A catalyst attachment-enhancing agent according to any one of claims 1 to 6, which has a pH of 9 to 13.

8. A process of performing direct electroplating on a palladium/tin colloidal catalyst applied for conductivity-imparting treatment of a nonconductor material which comprises, before application of said palladium/tin colloidal catalyst, treating said nonconductor material with a catalyst attachment-enhancing agent which comprises as an effective component a high molecular compound containing primary, secondary and tertiary amino groups.

9. A process according to claim 8, wherein said nonconductor material is an acrylonitrile-butandiene-styrene-resin or a polycarbonate-resin-blended acrylonitrile-butandiene-styrene alloy polymer.

10. A process according to claim 8 or 9, wherein said treatment with said catalyst attachment-enhancing agent is conducted at a temperature of 10 to 60° C.

11. A process according to any one of claims 8 to 10, wherein said treatment with said catalyst attachment-enhancing agent is conducted for 1 to 3 minutes.

12. A process according to any one of claims 8 to 11, wherein said catalyst attachment-enhancing agent has a pH of 9 to 13.

13. A process according to any one of claims 8 to 12, which does not require replacement of a rack.
